(19) United States
(12) Patent Application Publication
(10) Pub. No.: US 2007/0094455 A1
(43) Pub. Date: Apr. 26, 2007

(54) Device prestructured arrangement to allow selective monitoring of a data storage device

(76) Inventors: Kevin Dale Butt, Tucson, AZ (US); Paul Merrill Greco, Tucson, AZ (US); Arturo Avila Mojica, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/258,761

(22) Filed: Oct. 25, 2005

(51) Int. Cl. G06F 13/00

(52) U.S. Cl. 711/154

(57) ABSTRACT

In a data storage device, information regarding the operation of the device is gathered by a plurality of information providers or sources, such as counters, each configured to indicate a data point and/or count the occurrence of events with respect to the data storage device. A device control is configured to present an external prestructured arrangement of potential monitoring of the information providers, for external selective monitoring of a portion of the information providers in accordance with the prestructured arrangement. In one example, the prestructured arrangement is an ordered sequence of the information providers, for selective monitoring of a selected number of the information providers taken from the ordered sequence, such as the first “n” of the sequence.

### FIELD OF THE INVENTION

This invention relates to the monitoring of data storage devices, and, more particularly, to the monitoring of a data storage device by a system external to the device.

### BACKGROUND OF THE INVENTION

Data storage devices comprise large numbers of internal sources of information about the data storage device. Examples include counters for counting the occurrence of events with respect to the data storage device, and registers for providing data points, typically relating to the operation of the data storage device. The counters and registers are typically provided in the application system of the device control, and are incremented by activities, or store event values, or track inaction or errors by the data storage device. Herein, such sources or providers of information are termed “information providers”. Examples of data storage devices are magnetic tape drives which write data to and read data from magnetic tape, disk drives which write data to and read data from magnetic disks, optical drives which write data to and/or read data from optical disks, etc. These devices may have hundreds, perhaps a thousand, of these internal sources of information.

Some of the information is of interest to those who develop and test the data storage device, and some is of interest to the user of the data storage device. Typically, however, it is up to the external system in which the data storage device is located to develop or particularize a filter that is adapted to the external system, for example, to the number of available registers to which the information can be supplied and tracked, and to the communication system which is available to communicate to the data storage device, such as a SCSI communication system, and to determine what information would be useful to the user. The data storage device is often accompanied by a manual (hard or softcopy) which lists all of the available information providers, and it is up to the external system to select which of the information to monitor. For example, the external system may comprise a library or a RAID (Redundant Array of Independent Disks) with large numbers of data storage devices. Monitoring all of the information of every data storage device may not be practical. Therefore, the developer of the external system sets up the external system to monitor a limited set of information about each data storage device. The particular limited set of information may not necessarily satisfy the requirement each situation may have, and the developer may not know the data storage device sufficiently well to select the most ideal information.

### SUMMARY OF THE INVENTION

Data storage devices, data storage systems, and methods for providing the service of monitoring a data storage device from an external system, are provided. A data storage device comprises apparatus configured to store data to, and retrieve data from, a data storage medium; a plurality of information providers, each configured to indicate a data point and/or count the occurrence of events with respect to the data storage device; and a device control configured to present an external prestructured arrangement of potential monitoring of the information providers, for external selective monitoring of a portion of the information providers in accordance with the prestructured arrangement.

In a further embodiment, the prestructured arrangement comprises an ordered sequence, for selective monitoring of a selected number of the information providers taken from the ordered sequence.

In another embodiment, the prestructured arrangement comprises a grouped structure, for selective monitoring of selected groups of the information providers.

In a still further embodiment, the prestructured arrangement comprises a table and/or listing of monitoring information related to each of the information providers.

In still another embodiment, the monitoring information comprises external addressing information for the information provider. The external addressing information may comprise a query to access the information provider.

In a further embodiment, the monitoring information additionally comprises an identification of the information provided by the information provider.

For a fuller understanding of the present invention, reference should be made to the following detailed description taken in conjunction with the accompanying drawings.

### BRIEF DESCRIPTION OF THE DRAWINGS

FIG. 1 is a partially cut away view of a data storage device, comprising a magnetic tape drive, implementing the present invention;

FIG. 2 is a block diagram of the magnetic tape drive of FIG. 1;

FIG. 3 is a diagrammatic illustration of a table or listing of monitoring information related to each of the information providers of the data storage device of FIG. 1 arranged in a prestructured ordered arrangement in accordance with an embodiment of the present invention;

FIG. 4 is a diagrammatic illustration of a table or listing of monitoring information related to each of the information providers of the data storage device of FIG. 1 arranged in a prestructured grouped arrangement in accordance with an embodiment of the present invention; and

FIG. 5 is a flow chart depicting a method in accordance with an embodiment of the present invention.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

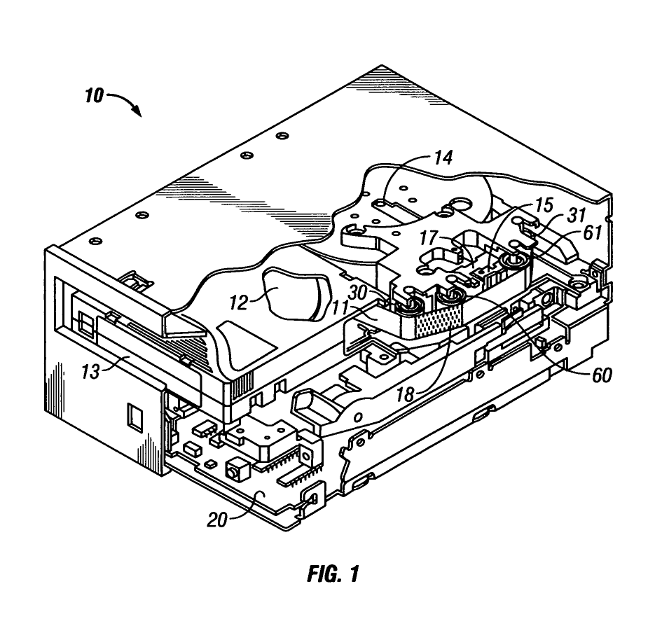

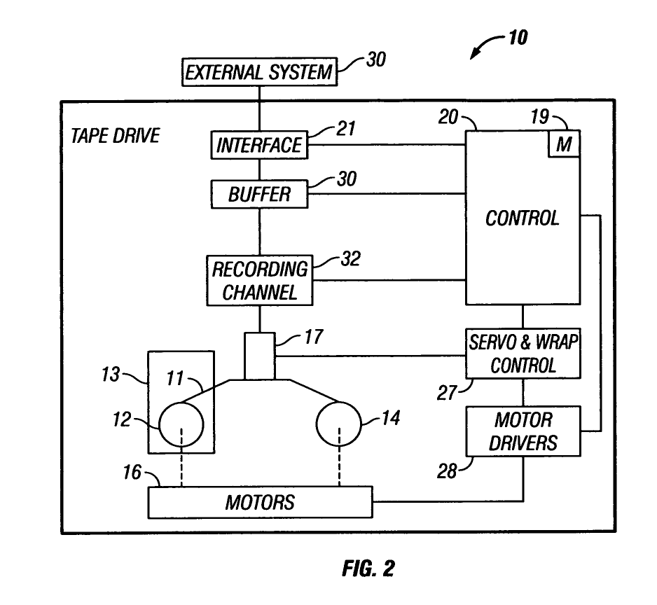

FIGS. 1 and 2 illustrate one type of data storage device, comprising a magnetic tape drive 10 which writes data to and reads data from magnetic tape 11. Other examples of data storage devices are disk drives which write data to and read data from magnetic disks, optical drives which write data to and/or read data from optical disks, etc.

As is understood by those of skill in the art, magnetic tape drives may take any of various forms. The illustrated magnetic tape drive 10 translates the magnetic tape 11 along a tape path in the longitudinal direction of the tape from a supply reel 12 in a tape cartridge 13 to a take up reel 14, the reels comprising drive reels of a tape drive system which are operated by drive motors 16. A single reel magnetic tape cartridge 13 is illustrated. An example of a magnetic tape drive 10 is the IBM 3592 TotalStorage Enterprise magnetic tape drive. Another example of a magnetic tape drive 10 is the IBM 3580 Ultrium magnetic tape drive. An alternative magnetic tape drive and magnetic tape cartridge is a dual reel cartridge in which both reels 12 and 14 are contained in the cartridge.

The magnetic tape 11 is moved in the longitudinal direction across a tape head 15.

The tape head may be supported and laterally moved by an actuator 17 of a track following servo system and wrap control system 27. A set of roller tape guides 30, 31, 60 and 61 hold the tape in position laterally, while motor drivers 28 operate the motors 16 to move the tape longitudinally. The drive motors are operated at various speeds as controlled by the motor drivers 28 to insure that tape leaves one reel at the same speed that it is wound onto the other reel.

The magnetic tape head 15 may comprise a plurality of read and write elements for respectively reading and writing data with respect to the magnetic tape 11, and may have one or more servo sensors for sensing servo tracks or bands 18 recorded on the magnetic tape. The servo sensor(s) may sense the lateral position of the magnetic tape and operate the servo system and actuator 17, 27 to track follow the servo tracks or bands. The servo sensor may also detect the longitudinal position of the tape from the servo tracks or bands. The magnetic tape 11 may have a number of parallel tracks, each of which corresponds to a read and a write element of the magnetic tape head 15. The tracks may be arranged in a back and forth serpentine pattern, each set of tracks called a “wrap”, or may be arranged as sets of bands which may be read in both directions. The tape 11 may be moved in a first (or forward) direction from the supply reel 12 to the take up reel 14 while the track following servo follows one wrap or set of tracks, and then the servo and wrap control may operate the actuator 17 to shift the magnetic tape head laterally to another wrap, and the magnetic tape 11 moved in the opposite (or reverse) direction from the take up reel 14 to the supply reel 12 while the track following servo follows the other wrap or set of tracks.

Also as understood by those of skill in the art, a magnetic tape drive 10 comprises one or more controls 20 for operating the magnetic tape drive in accordance with commands received from an external system 30 received at an interface 21. The external system 30 may comprise a network, a host system, a data storage library or automation system, a data storage subsystem, etc., as is known to those of skill in the art. A control typically comprises logic and/or one or more microprocessors with a memory 19 for storing information and program information for operating the microprocessor(s) and drive. The program information may be supplied to the memory via the interface 21, by an input to the control 20 such as a floppy or optical disk, or by reading from a magnetic tape cartridge, or by any other suitable means. The magnetic tape drive 10 may comprise a standalone unit or comprise a part of a tape library or other subsystem, which may comprise the external system 30.

The control 20 also provides the data flow and formatter for data to be read from and written to the magnetic tape, employing a buffer 30 and a recording channel 32, as is known to those of skill in the art.

Data storage devices, such as magnetic tape drive 10, comprise large numbers of internal sources of information about the data storage device. Examples include counters for counting the occurrence of events with respect to the data storage device, and registers for providing data points, typically relating to the operation of the data storage device. The counters and registers are typically provided by the control 20, and are incremented by activities, or store event values, or track inaction or errors by the data storage device. As discussed above, herein, such sources or providers of information are termed “information providers”. These devices may have hundreds, perhaps a thousand, of these internal sources of information.

Some of the information is of interest to those who develop and test the data storage device, and some is of interest to the user of the data storage device. Typically, however, it is up to the external system 30 in which the data storage device is located to develop or particularize a filter that is adapted to the external system, for example, to the number of available registers to which the information can be supplied and tracked, and to the communication system which is available to communicate to the data storage device, such as a SCSI communication system, and to determine what information would be useful to the user. The data storage device is often accompanied by a manual (hard or softcopy) which lists all of the available information providers, and it is up to the external system to select which of the information to monitor.

For example, the external system 30 may be a data storage library in which the data storage device 10 is located, and the library may monitor information about all of the devices in the library. However, the library may have the capability of monitoring 30 information sources for this particular device because of the large number of devices in the library, whereas the device has over 500 information sources. The library may establish 30 of the information sources to monitor, but another situation may exist for another similar library such that the library may establish 50 of the information sources to monitor.

In accordance with an embodiment of the present invention, the device control 20 is configured to present an external prestructured arrangement of potential monitoring of the information providers. The prestructured arrangement is complete, covering all of the available information providers. The external system 30 then selects a portion of the information providers to monitor, the selection in accordance with the prestructured arrangement.

Thus, the developer or user of the external system 30 does not have to attempt to define the most appropriate information providers to monitor. Further, the developer or user of the external system is less likely to have the expertise to select the more important device information to monitor.

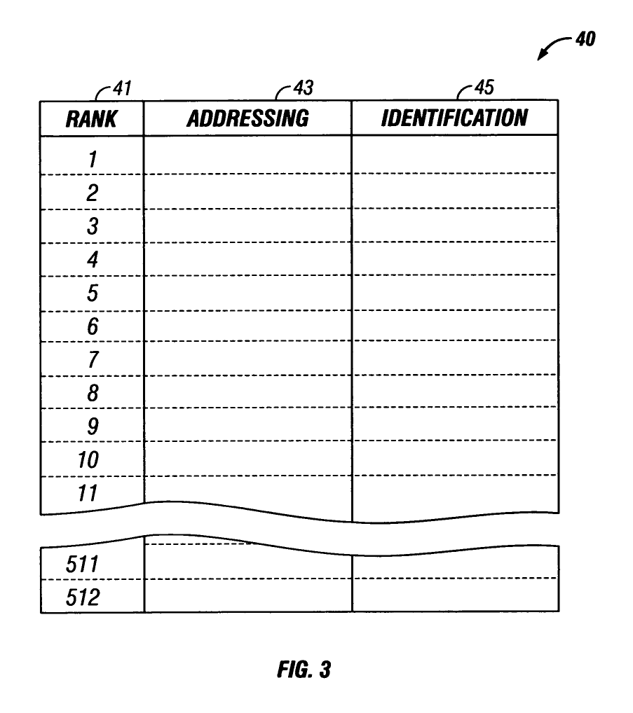

Referring additionally to FIG. 3, in one embodiment, the prestructured arrangement comprises an ordered sequence, shown as a table or list 40. The arrangement is defined and maintained by the control 20, for example, in memory 19. The ordered sequence in the example is shown as ordered by “RANK” number 41. The external system 30 then selects the number of information providers to monitor taken from the ordered sequence. For example, if the external system wants to monitor 30 information providers, those in the list 40 are selected to include the information providers from rank 1 to rank 30.

Still referring to FIGS. 1, 2 and 3, in one embodiment, the monitoring information comprises external addressing information 43 for the information provider. Thus, not only is the external system 30 provided with the recommended ordering of interesting information, the system is also provided with the knowledge of where/how to get it.

As an example, the structure of the addressing information may comprise the “log page number”, the “log subpage number”, and the “counter number”.

The external addressing information may comprise a query or the information to build a query to access the information provider.

As an example, the structure may also include the reporting mechanism, for example:
“log sense”
“mode sense”
“read buffer” or
“sense data”,

together with page offsets lengths, masks (to indicate the structure for the reporting mechanism).

In a further embodiment, the monitoring information may additionally comprise an identification 45 of the information provided by the information provider, such as a name or a field identifier (a string name of the field which might have meaning to a user of the device), such that the user may understand what the information provider relates to.

Further information may comprise an indicator of the importance of the information provider, akin to the ranking 41, but a relational value and not a sequential value. For example, the information provider may be given an importance of “3”, while the next information provider may be given an importance of “5”. As another example, multiple information providers may have the same importance.

Referring to FIGS. 1, 2 and 4, in one embodiment, the prestructured arrangement comprises a grouped structure, for selective monitoring of selected groups of the information providers. The prestructured arrangement comprises a grouping of the information providers into related groups, shown as a table or list 50. The arrangement is defined and maintained by the control 20, for example, in memory 19. The groupings in the example are shown as “GROUP” 51. The information providers may be further organized by ranking or importance within the groups, as identified by “RANK” number 52. Further, the groups may be arranged in the order of importance to the external system 30.

The external system 30 then selects the number of information providers to monitor taken by group. For example, the external system may select the first “n” groups of information providers to monitor. Alternatively, the external system may select the all of the information providers in the first “x” groups, and then selects only the most important information provider in the next “y” groups, and select none from the remaining groups.

As discussed above, and still referring to FIGS. 1, 2 and 4, in one embodiment, the monitoring information comprises external addressing information 53 for the information provider. This addressing information would be the same as discussed above. Thus, not only is the external system 30 provided with the recommended ordering of interesting information, the system is also provided with the knowledge of where/how to get it.

In a further embodiment, also as discussed above, the monitoring information may additionally comprise an identification 54 of the information provided by the information provider, such as a name or a field identifier, such that the user may understand what the information provider relates to.

Again, further information may comprise an indicator of the importance of the information provider, either akin to the ranking or item number 52, as above, or a relational value and not a sequential value. For example, the information provider may be given an importance of “3”, while the next information provider may be given an importance of “5”. As another example, multiple information providers may have the same importance.

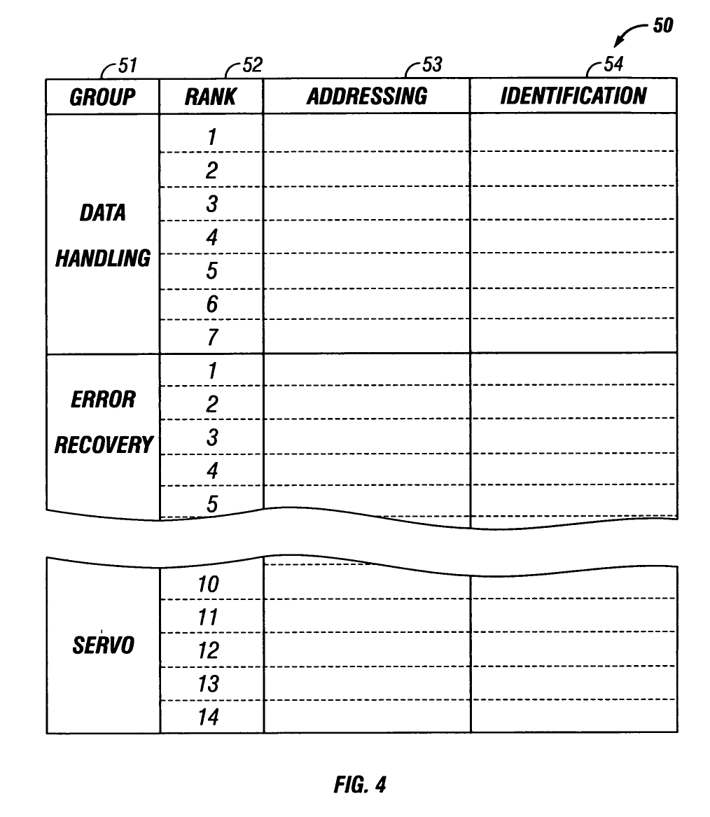

Referring to FIGS. 3 and 4, examples of information providers may comprise:

Of Interest to External System:

“Volume Mounts”
“Device Write Kilobytes Processed”
“Device Read Kilobytes Processed”
“Drive Lifetime Megabytes Written”
“Volume Lifetime Megabytes Written”
“Number of Error Recovery Procedures (ERP) Invoked”, etc.
   Low Interest to External System:

“Servo Channel Resets (Inbound)”—counts the number of times a track following servo has reset to another servo channel to use another set of servo readers to read another set of servo tracks (18 in FIG. 1), “Inbound” refers to the tape moving forward, to the take up reel.

“Servo Channel Resets (Outbound)”—“Outbound” refers to the tape moving in reverse, to the supply reel.

“ERP Servo Adjust Hi”—counts the number of times a track following servo has adjusted its path higher on the tape for error recovery to better align with the data tracks.

“ERP Servo Adjust Lo”—counts the number of times a track following servo has adjusted its path lower on the tape for error recovery to better align with the data tracks.

The data storage drive thus presents the external system 30 with the ability to access the most important counters and data points of interest to the external system, and selects those counters and data points in accordance with the presented arrangement. An example may comprise: command=log sense; log page=x38; counter=x0002; name=“Host Read Blocks Processed”; rank=10. To get the value of the counter, a logsense command to page x38 is issued and counter x0002 is parsed and presented if rank 10 is important enough to be accessed.

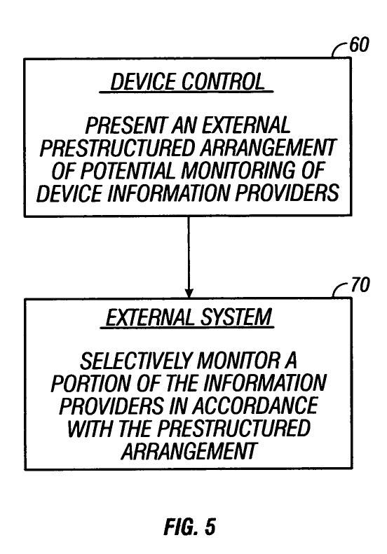

FIG. 5 depicts a method in accordance with an embodiment of the present invention for providing the service of monitoring a data storage device from an external system.

In step 60, the device control presents to the external system an external prestructured arrangement of potential monitoring of the information providers.

As discussed above, in one embodiment, the device control presents the external prestructured arrangement as an ordered sequence.

In an alternative embodiment, the device control presents the external prestructured arrangement as a grouped structure.

The device control may present the external prestructured arrangement as a table and/or listing of monitoring information related to each of the information providers.

Additionally, the monitoring information may comprise external addressing information, as discussed above for gaining access to the information provider. In one example, the external addressing information comprises a query to access the information provider. Thus, the external system is provided with the recommendation of interesting information, and the external system is also provided with the knowledge of where/how to get it.

Further, the monitoring information additionally comprises an identification of the information provided by the information provider, such as a name or a field identifier, such that the user may understand what the information provider relates to.

In step 70, the external system selectively monitors a portion of the information providers in accordance with the prestructured arrangement. In the embodiment wherein the device control presents the external prestructured arrangement as an ordered sequence, in step 70, the external system monitors a selected number of the information providers taken from the ordered sequence, as discussed above.

In the embodiment wherein the device control presents the external prestructured arrangement as a grouped structure, the external system monitors selected groups of the information providers.

The list or table is more likely arranged for machine interfaces, and not for a human user. The list or table thus presents what is likely to be of interest, and also what to ignore. The list or table may alternatively be made available for customization by the external system, and the counters and data points used could be altered by a user (operator), for example, via a GUI, as is known to those of skill in the art.

Those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A data storage device, comprising:
apparatus configured to store data to, and retrieve data from, a data storage medium;
a plurality of information providers, each configured to indicate a data point and/or count the occurrence of events with respect to said data storage device; and
a device control configured to present an external prestructured arrangement of potential monitoring of said information providers, for external selective monitoring of a portion of said information providers in accordance with said prestructured arrangement.

2. The data storage device of claim 1, wherein said device control presented external prestructured arrangement comprises an ordered sequence, for selective monitoring of a selected number of said information providers taken from said ordered sequence.

3. The data storage device of claim 1, wherein said device control presented external prestructured arrangement comprises a grouped structure, for selective monitoring of selected groups of said information providers.

4. The data storage device of claim 1, wherein said device control presented external prestructured arrangement comprises a table and/or listing of monitoring information related to each of said information providers.

5. The data storage device of claim 4, wherein said monitoring information comprises external addressing information for said information provider.

6. The data storage device of claim 5, wherein said external addressing information comprises a query to access the information provider.

7. The data storage device of claim 5, wherein said monitoring information additionally comprises an identification of the information provided by said information provider.

8. A data storage system, comprising:
an external system configured to communicate with a data storage device;
a data storage device, comprising:
apparatus configured to store data to, and retrieve data from, a data storage medium;
a plurality of information providers, each configured to indicate a data point and/or count the occurrence of events with respect to said data storage device; and
a device control configured to communicate with said external system to present to said external system an external prestructured arrangement of potential monitoring of said information providers, for external selective monitoring by said external system of a portion of said information providers in accordance with said prestructured arrangement.

9. The data storage system of claim 8, wherein said device control presented external prestructured arrangement comprises an ordered sequence, for selective monitoring by said external system of a selected number of said information providers taken from said ordered sequence.

10. The data storage system of claim 8, wherein said device control presented external prestructured arrangement comprises a grouped structure, for selective monitoring by said external system of selected groups of said information providers.

11. The data storage system of claim 8, wherein said device control presented external prestructured arrangement comprises a table and/or listing of monitoring information related to each of said information providers.

12. The data storage system of claim 11, wherein said monitoring information comprises external addressing information for said information provider.

13. The data storage system of claim 12, wherein said monitoring information additionally comprises an identification of the information provided by said information provider.

14. A method for providing the service of monitoring a data storage device from an external system, said data storage device comprising apparatus configured to store data to, and retrieve data from, a data storage medium; a plurality of information providers, each configured to indicate a data point and/or count the occurrence of events with respect to said data storage device; and a device control, said method comprising the steps of:
said device control presenting to said external system an external prestructured arrangement of potential monitoring of said information providers; and
said external system selectively monitoring a portion of said information providers in accordance with said prestructured arrangement.

15. The method of claim 14, wherein said device control presents said external prestructured arrangement as an ordered sequence; and said external system monitors a selected number of said information providers taken from said ordered sequence.

16. The method of claim 14, wherein said device control presents said external prestructured arrangement as a grouped structure; and said external system monitors selected groups of said information providers.

17. The method of claim 14, wherein said device control presents said external prestructured arrangement as a table and/or listing of monitoring information related to each of said information providers.

18. The method of claim 17, wherein said monitoring information comprises external addressing information for said information provider.

19. The method of claim 18, wherein said external addressing information comprises a query to access the information provider.

20. The method of claim 18, wherein said monitoring information additionally comprises an identification of the information provided by said information provider.
